(19) United States
(12) Patent Application Publication
(10) Pub. No.: US 2004/0253433 A1
(43) Pub. Date: Dec. 16, 2004

(54) Electrical stress control article

(76) Inventors: David Francis Pearce, Wiltshire (GB); Sean Michael Lewington, Wiltshire (GB); John David Stoker, Wiltshire (GB); James Richard Broomham, Wiltshire (GB); David James Scurr, Lancashire (GB)

Correspondence Address: MYERS BIGEL SIBLEY & SAJOVEC, PO BOX 37428, RALEIGH, NC, 27627, US

(21) Appl. No.: 10/494,236

(22) PCT Filed: Nov. 8, 2002
(86) PCT No.: PCT/GB02/05062

(30) Foreign Application Priority Data
Nov. 15, 2001 (GB) 0127387.9

(51) Int. Cl. B32B 3/26

(52) U.S. Cl. 428/304.4

(57) ABSTRACT

A sheet-like electrical stress control article includes at least one void-filling layer of elastomeric void-filling material having some electrical stress control functionality (for example, containing 20 to 70% by weight of electrically conductive or semi-conductive fillers) and at least one support layer of elastomeric material selected and/or formulated (for example, with 45 to 65% by weight fillers) to require increasing applied stress to produce therein a given unit of strain as it approaches its break point The thickness and composition of the respective layers are selected so that the article is stretchable during application thereof to parts of a cable and the increasing stress required to stretch the support layer resists over-elongation of the void-filling layer.

This invention relates to an electrical stress control article for use in splicing and termination of medium-to-high voltage (up to 42 Kv) power cables.

When splicing or terminating low-to-medium voltage cable, it is usual to provide a void-filling material, which can be a hand-wound tape, around the region where the cable screen ends after it is cut back to expose the underlying insulation and conductive core of the cable. Layers of other materials, usually in tubular form, are applied over the hand-wound tape to perform the necessary stress-grading and insulating functions in the finished joint or termination. The void-filling material fills voids which would otherwise tend to generate arcs when the cable is under power in use, and the material can also enhance the stress-grading effect to further reduce the risk of over-voltage insulating failure in the region of the cut-back screen end.

A good self-amalgamating void-filling tape of epichlorohydrin polymer for low-to-medium-voltage use is available under the trade mark Raychem S1189, but this tape is easily over-stretched during hand wrapping and is less satisfactory at medium-to-high voltages, especially when the cable splice or termination is required to pass specifications CENELEC HD 629.SI:1996 for 36 kV and 42 kV power cables and IEEE 48-1996 for 45 kV power cables.

It is an object of the present invention to provide a stress control article which is more suitable for use at medium-to-high voltages and which better meets the requirements of the aforementioned specifications.

The invention accordingly provides a sheet-like electrical stress control article comprising (a) at least one void-filling layer of elastomeric void-filling material having some electrical stress control functionality and (b) at least one support layer of polymeric material selected and/or formulated to require increasing applied stress to produce therein a given unit increase in strain as it approaches its break point, wherein the thickness and composition of the respective layers are selected so that the article is stretchable during application thereof to parts of a cable (preferably by wrapping, especially hand-wrapping) and the increasing stress required to stretch the support layer resists over-elongation of the void-filling layer.

It has been found advantageous thus to separate the void-filling/stress-grading functions from the support/stretch-limiting functions by means of separate layers in the article according to the present invention. Neither the void-filling layer alone, nor the support layer alone, has been found capable of meeting the requirements of the aforementioned specifications at medium-to-high voltages, especially in respect of maintaining low partial discharge values throughout the load cycling stage of the test specifications. The layered article of the present invention uniquely passes the test specifications and is convenient to apply by hand or otherwise. The initial stretchability of the article enables it to be wrapped closely around the cable structures in question, preferably with less than 80%, more preferably less than 75%, especially less than 70%, or minimal, instantaneous elastic recovery; and its subsequent progressive increase in applied stress required to increase further its strain or degree of stretch enables wrapping pressure to be applied, to force the void-filling material into the spaces or voids to be filled, while preventing over-stretching of the void-filling layers to an extent which would reduce their practical effectivness. This self-limiting stretchability, hereinafter referred to as “work stiffening”, provided by the support layer(s) is believed to be primarily due to progressive alignment of the polymer chains in the polymeric support layer with increasing strain. The polymer(s) of the support layer may be selected and formulated accordingly to display such work stiffening, preferably to reach a “lock” point where further stretching or strain substantially ceases at an applied tension which is below that required to break the stretched support layer. Preferably, the article according to this invention is constructed to be initially hand-stretchable, preferably at an initially applied stress of less than 1 MPa at 23° C., up to a strain of at least 300%; and preferably the article is constructed to require at least doubling of the initially applied stress, preferably to a level greater than 1.5 MPa, in order to produce work stiffening and substantial cessation of stretching at a strain approaching, but below, its tensile failure strain, preferably above 800 to 1200% strain.

A preferred article according to this invention comprises three or more of the said layers alternating with one another, more preferably one said support layer sandwiched between two said void-filling layers. Suitable polymers for the respective layers may be selected by simple trial and error, but it may be preferable that the or each void-filling layer comprises 30 to 80% by weight of elastomeric polymer selected from EPDM, polybutadiene, nitrile rubbers, butyl rubbers, polyisobutylene, amorphous polypropylene, thermoplastic elastomers, and blends thereof, 70 to 20% by weight of electrically conductive or semiconductive fillers to provide the layer with stress-grading functionality, and up to a 10% by weight of tackifiers, antioxidants or other additives, to a total of 100% by weight of the whole void-filling layer composition.

The article according to this invention is preferably constructed so that the or each void filling layer has a thickness within the range of 0.25 to 5 mm, preferably 0.5 to 3 mm, more preferably 0.75 to 1.5 mm and/or so that the or each support layer has a thickness within the range of 0.1 to 4 mm. preferably 0.3 to 2.5 mm, more preferably 0.5 to 1.5 mm. The preferred form of the article is a sheet, tape, film, or patch, especially an elongate tape for hand-wrapping around the cut-back screen region of a power cable to be spliced or terminated.

The article may be made by any convenient methods and equipment, known per se, preferably by extrusion of at least some of the layers. Extrusion of the or each void-filling layer onto a surface of a support layer is preferred, possibly by co-extrusion of the layers, but more preferably by extrusion of the or each void-filling layer individually onto a support layer, preferably a pre-existing support layer. The ingredients of the layer material compositions may be mixed using any convenient techniques and equipment, generally as known per se.

The invention may be better understood by reference to the following drawings and formulations, provided by way of example, describing a typical design of a 3 layer tape construction.

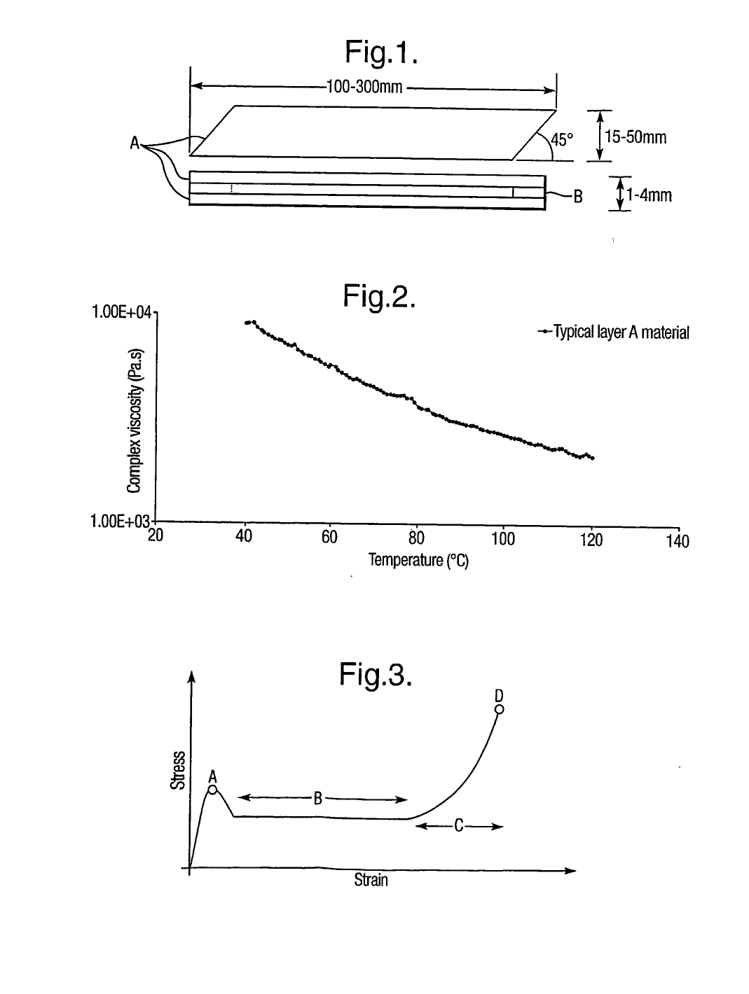

Referring to the drawing FIG. 1, Layer/s A (Outer layer/s) are the void-filling layers, whose primary function is as a void-filler to exclude air-gaps from the critical screen cutback region, and whose secondary function is to provide some electrical stress control to help ensure that no electrical discharges or failures will occur in the screen cut-back region, even if small voids or contaminants are present. Preferred thickness of the or each void-filling layer to perform both of these functions is 0.75- 1.25mm.

Typical Materials:

Elastomeric carrier (e.g. EPDM, PIB, amorphous polypropylene, thermoplastic elastomers, etc) or elastomer blends, and suitable stress-grading fillers (e.g. carbon black, titanium dioxide, silicon carbide, doped zinc oxide, etc) and other additives. A typical formulation for the void-filling layers is shown in Table 1.

TABLE 1
Typical formulation for Layer A material
Ingredients (%-by-weight)

| Amorphous | Poly- | | Carbon | Silicon | Anti- |
|---|---|---|---|---|---|
| Polypropylene | isobutylene | Tackifier | Black | Carbide | oxidant |
| 7.6 | 29.5 | 4.0 | 28.6 | 29.8 | 0.5 |

The amorphous polypropylene was a grade with a softening point of approximately 105° C. and a melt viscosity of approximately 3500 mPa.s at 190° C.

The polyisobutylene was a material with and average molecular weight of approximately 40,000.

The tackifier was a hydrogenated hydrocarbon with a softening point of approximately 85° C. and a melt viscosity of approximately 250 mPa.s at 150° C.

The carbon black was a grade classified as an N990-type in accordance with ASTM D1765.

The silicon carbide was an electrical grade, of 400 grit size.

The antioxidant was a phenolic type with a melting point of approximately 75° C.

Typical Theological behaviour for the illustrated void-filling Layer A material is shown in the FIG. 2 graph of complex viscosity (Pa.s) against temperature.

The material will preferably have some inherent electrical stress control properties, and this can be achieved in a number of ways known per se, for example incorporation of active stress control fillers, carbon black based systems, etc.

Layer B (Central layer) in the foregoing FIG. 1 is the support layer, whose primary function is to act as a physical support to enable the softer material in Layer/s A to be applied evenly and without breaking and whose secondary function is to provide a physical ‘locking point’ during stretching of the tape, such that it cannot be over-extended. This is to prevent the Layer/s A material being drawn down to a level which is too thin to meet performance requirements.

Typical Materials: Elastomeric carrier (e.g. EPDM, Butyl rubber, thermoplastic elastomers, liquid elastomers, etc) or elastomer blends, and suitable fillers/additives (e.g. carbon black, titanium dioxide, and possibly stress-grading materials such as silicon carbide, doped zinc oxide, etc, although stress-grading is not an essential function of the support layer). A typical formulation for the support layer is shown in Table 2.

TABLE 2
Typical formulation for Layer B material
Ingredients (%-by-weight)

| High Molecular | Low Molecular | | | |
|---|---|---|---|---|
| weight butyl | weight butyl | Carbon | Titanium | |
| rubber | rubber | Black | Dioxide | Antioxidant |
| 39.5 | 5 | 10 | 45 | 0.5 |

The high-molecular weight PIB (polyisobutylene) butyl rubber was a grade with an average molecular weight of approximately 2.11×10⁶.

The low-molecular weight PIB rubber was a material with an average molecular weight of approximately 40,000.

The carbon black was a grade classified as an N990-type in accordance with ASTM D1765.

The titanium dioxide was an industry-standard high-purity pigment grade.

The antioxidant was a phenolic type with a melting point of approximately 75° C.

Typical performance of the support layer is indicated in the following schematic stress/strain graph FIG. 3, where region A is the initial yielding of the layer as the applied stress increases, region B is the relatively easy stretching at more-or-less-constant stress, region C is the “work stiffening” of the material as stretching increases, and region D is the point of ultimate breaking at an applied stress preferably higher than that likely to be applied during hand wrapping and stretching.

The stress-strain behaviour of the Layer B material, as shown schematically in FIG. 3, demonstrates four distinct regions:

Point A This is the point at which the material begins to yield, and this can be considered as the initial resistance to ‘drawing’ by hand. This is ideally quite low (typical stress: 0.3-0.8 MPa at 23° C.).

Region B This is the region where the tape thickness and width decrease as the material is drawn-down. The material begins to ‘work-stiffen’ towards the end of this region, as the polymer chains begin to align with elongation.

Region C This region is where the effective modulus of the material increases dramatically due to the ‘work-stiffening’ effect. The bulk of the polymer chains align in this area of the stress-strain curve, and the modulus increases as a result of the increased inter-chain bonding.

Point D This is the tensile failure point for the material, where it reaches its ultimate tensile stress. This value should be high, as this creates a physical ‘lock’ in the material which helps to prevent the installer over-extending or snapping the tape product. Typical useable material values are 1.8-2.8 Mpa.

1. A sheet-like electrical stress control article comprising
at least one void-filling layer of elastomeric void-filling material having electrical stress control functionality; and
at least one support layer of elastomeric material selected and/or formulated to require increasing applied stress to produce therein a given unit of strain as it approaches its break point; and
wherein a thickness and composition of the respective layers are selected so that the article is stretchable during application thereof to parts of a cable and the increasing applied stress required to stretch the support layer resists over-elongation of the void-filling layer.

2. An article according to claim 1, comprising at least three of the void-filling layers and support layers alternating with one another.

3. An article according to claim 2, wherein the at least one support layer is sandwiched between two of the void-filling layers.

4. An article according to claim 1, wherein the at least one void-filling layer comprises 30% to 80% by weight of an elastomeric polymer selected from EPDM, polybutadiene, nitrile rubbers, butyl rubbers, polyisobutylene, amorphous polypropylene, thermoplastic elastomers, and blends thereof, and 70% to 20% by weight of electrically conductive and/or semiconductive fillers to provide the at least one void filling layer with stress-grading functionality, and up to 10% by weight of tackifiers, and/or antioxidants, and/or other additives.

5. An article according to claim 4, wherein the at least one void filling layer comprises 5% to 10% amorphous polypropylene, 25% to 35% polyisobutylene, 2% to 6% resin and/or rosin tackifier, 25% to 35% carbon black, 25% to 35% silicon carbide, and 0.3% to 0.7% antioxidant.

6. An article according to claim 1, wherein the at least one support layer comprises 35% to 55% by weight of an elastomeric polymer selected from EPDM, polybutadiene, nitrile rubber, butyl rubber, polyisobutylene, thermoplastic elastomers, and blends thereof, 65% to 45% by weight of fillers, and up to 2% by weight antioxidants and/or other additives.

7. An article according to claim 6, wherein the at least one support layer comprises 35% to 45% high-molecular-weight polyisobutylene, 3% to 7% low-molecular-weight polyisobutylene, 7% to 13% carbon black, 40% to 50% titanium dioxide, and 0.3% to 0.7% antioxidant.

8. An article according to claim 1, that is hand-stretchable at an applied stress.

9. An article according to claim 8, that requires at least doubling of the applied stress, to produce work stiffening and substantial cessation of stretching at a strain approaching, but below, its tensile failure strain.

10. An article according to claim 1, wherein the thickness of the at least one void filling layer is from 0.25 mm to 5 mm.

11. An article according to claim 1, wherein the thickness of the at least one support layer is from 0.1 mm to 4 mm.

12. An article according to claim 1 wherein the article comprises a sheet, tape, film, or patch.

13. An article according to claim 1 wherein at least one of the layers has been extruded.

14. An article according to claim 13, wherein the at least one void-filling layer has been extruded onto a surface of the at least one support layer.

15. An article according to claim 1 wherein the at least one void-filling layer includes 20% to 70% by weight of elastomerically conductive and/or semi-conductive fillers.

16. An article according to claim 15 wherein the at least one support layer includes 45% to 65% by weight fillers.

17. An article according to claim 8 wherein the article is hand stretchable at an applied stress of less than 1 MPa at 23° C., up to a strain of at least 300%.

18. An article according to claim 9 wherein at least doubling the applied stress comprises an applied stress at a level above 1.5 Mpa.

19. An article according to claim 18 wherein substantial cessation of stretching is provided at 800% to 1200% strain.

20. An article according to claim 10 wherein the thickness of the at least one void filling layer is from 0.5 mm to 3 mm.

21. An article according to claim 20 wherein the thickness of the at least one void filling layer is from 0.75 mm to 1.5 mm.

22. An article according to claim 11 wherein the thickness of the at least one support layer is from 0.3 mm to 2.5 mm.

23. An article according to claim 22 wherein the thickness of the at least one support layer is from 0.5 mm to 1.5 mm.
